(19) United States
(12) Patent Application Publication
(10) Pub. No.: US 2006/0008143 A1
(43) Pub. Date: Jan. 12, 2006

(54) Hierachical image segmentation

(76) Inventors: Roel Truyen, Eindhoven (NL); Steven Lobregt, Eindhoven (NL); Frans Andreas Gerritsen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/531,023

(22) PCT Filed: Sep. 12, 2003
(86) PCT No.: PCT/IB03/04142

§ 371 Date: Apr. 12, 2005

(30) Foreign Application Priority Data
Oct. 16, 2002 (EP) 02079278.4

(51) Int. Cl. G06K 9/34; G06K 9/00

(52) U.S. Cl. 382/173; 382/128

(57) ABSTRACT

An apparatus 1000 includes an input 1010 for receiving an N-dimensional signal, N≧2. A storage 1030 stores a composite model of a composite structure for estimating parameters of the model with respect to the signal. The composite model is based on constituent models 210-290 that each correspond to a constituent structure in the signal and that are incorporated in the composite structure. Each constituent model is designated for estimating parameters of the constituent model with respect to the signal based on prior knowledge of the constituent structure. At least two of the constituent models are based on differing technologies. Each constituent model is provided with a uniform interface for controlling the constituent model and for retrieving parameters estimated by it. A processor 1020 is programmed to estimate the model parameters by controlling the constituent models to estimate their parameters; to retrieve estimated parameters from the constituent models; and to estimate parameters of the model in dependence on the retrieved parameters.

### FIELD OF THE INVENTION

The invention relates to estimating parameters of a model of a composite structure with respect to an N-dimensional signals (N≧2), in particular for segmenting 2-, 3-, or 4-dimensional medical images. The invention also relates to a method of constructing such models. The invention further relates to an apparatus for estimating parameters of such a model.

### BACKGROUND OF THE INVENTION

With the increase of high quality digital input signals and the increase in processing power, image segmentation has become an important area. With image segmentation is meant the process of identifying regions, or objects of interest in pictures or images. For example, in an X-ray photograph depicting a human chest, potentially desirable segmentation would identify any or all forms of a heart, left lung, right lung, ribs and spine. Segmentation is particularly important in the area of medical imaging and industrial machine vision, mainly for 2-dimensional, 3-dimensional image or 4-dimensional images. The 3-dimensional image can be a ‘stack’ of 2-dimensional images where each image is taken at a different depth or a 2-dimensional image with time information (i.e. a time sequence of 2-dimensional images). Typically, the 4-dimensional image is formed by a time sequence of 3-dimensional images (with x, y, z position information).

Segmenting can be used for various purposes, like visualization (e.g. display or highlighting of a kidney), measurement (e.g. measuring the curvature of a spine), and planning of a successive operation (e.g. planning of an area to be radiated). As such, segmenting can be used as a pre-processing step in more general processing of N-dimensional signals (N≧2). More in general, the invention relates to fitting a model to the N-dimensional signal. The outcome of the fitting is a set of parameters that represent the fitting of the model to the signal. This may be a measure of how well the model fits the signal (e.g. a likelihood), it may be a location or length of a main axis of the model, a measurement on the signal (e.g. speed of a blood flow), etc. Nowadays for medical applications, usually main output parameters of fitting a model to a signal is the identification of the region/object of interest (i.e. a segmentation), possibly followed by post-processing on that region/object. As such, the emphasis will be on segmenting images.

Many methods of performing image segmentations have been developed. U.S. Pat. No. 6,031,935 describes a method and apparatus of image segmentation (a “segmenter”) that employs a combination of image intensity information, user-supplied information, and a-priori domain knowledge particular to the type of problem at hand, to segment images.

Particularly in the medical area, much effort is used to develop specific models, such a model for a heart, vein, spine, etc., based on a-priori knowledge. In general these models are coded for the specific application they were designed for and can not easily be re-used for other applications without a high amount of re-coding of the software. Consequently, progress that is made in the development in one model can not be extended easily to other models.

### SUMMARY OF THE INVENTION

It is an object of the invention to enable quick development of new models for fitting to a signal. It is a further object of the invention to enable re-use of existing models. It is a further object to improve the quality of fitting of a model to a signal.

To meet the object of the invention, a method of constructing a model of a composite structure for estimating parameters of the model with respect to an N-dimensional signal, N≧2, in particular for segmenting a medical image, includes:
constructing a plurality of constituent models, each constituent model corresponding to a respective predetermined constituent structure and being designated for estimating parameters of the constituent model with respect to the N-dimensional signal based on respective prior knowledge of the constituent structure, at least two of the constituent models being based on differing technologies; and each constituent model being provided with a uniform, predetermined interface for controlling the constituent model and for retrieving parameters estimated by the constituent model; and
constructing the model by determining at least two constituent structures that are incorporated in or related to the composite structure and forming the composite model based on respective constituent models that correspond to the respective determined constituent structures; the model being operative to control the constituent models, to retrieve estimated parameters from the constituent models and to estimate parameters of the model in dependence on the retrieved parameters.

According to the invention, a model that is designated to segment a composite structure uses constituent models, that each try to find their most plausible solution in the signal (e.g. 2-dimensional image). Each constituent model is designated to estimate parameters of a constituent structure that is incorporated in or related to the composite structure. With structure is meant an area or object of interest in the signal, for example a heart in a chest X-ray. In itself it is not relevant how such a constituent model operates. For example, it can be based on image information itself (how well does the model correspond to the image information), on the likelihood of the solution, or a combination of these. Such behavior can be expressed by minimizing the energy of the model, or—equivalently—by maximizing the likelihood of the solution. According to the invention, at least two of the constituent models are based on differing technologies, optimized for the constituent structure. The different technology may, for example, lie in a different internal representation (e.g. models for geometrical primitive structures, models for active objects, level set, etc.) and/or in a way of fitting the model to the structure (e.g. based on a transition between bone and tissue, transition between air and tissue, differences in texture, etc.). The constituent models are all provided with a uniform interface for controlling the models. This enables building a framework of models wherein a higher level model (for segmenting a composite structure) is built using constituent models for the constituent structures in the composite structure. A model for a composite structure will also be referred to as composite model. In the remainder, the models will be described with reference to segmenting medical images. It will be appreciated that the techniques according to the invention are more generally applicable to estimating model parameters (i.e. parameters of the structure represented by the model) with respect to a N-dimensional signal.

The article “Anatomical Modeling with Fuzzy Implicit Surfaces: Application to Automated Localization of the Heart and Lungs in Thoracic MR Images” of Lelieveldt e.a., proc. Information Processing in Medical Imaging, vol. 1613 of Lecture Notes in Computer Science, Springer Verlag, Berlin, pp. 400-405, 1999, describes a model driven segmentation approach for thoracic MR-images. The described model coarsely, but fully automatically localizes the boundary surfaces of the heart and lungs in thoracic MR sets. The major organs in the thorax are described in a three-dimensional analytical model template by combining a set of fuzzy implicit surfaces by means of Constructive Solid Geometry, and formulating model registration as an energy minimization. All constituent structure are modeled in the same way using 3D implicit surfaces, that can be seen as (fuzzy) binary volumes. A composite model is created by combining constituent models (each represented by fuzzy binary volumes) to more complex structure using logical operators (AND, OR, SUB). This technique is known as Constructive Solid Geometry (CSG) and requires that all constituent models are represented in the same way (as fuzzy binary volumes). No other technologies can be used. Unlike the models according to the invention, the known approach is not open and can not accommodate techniques that are actually more suited for a specific constituent structure.

As described in the dependent claim 2, a constituent model may be a primitive model developed for estimating parameters of respective primitive structures, such as a left lung, right lung and a heart, solely using a-priori knowledge of the object and without the use/assistance of other models. These three primitive models may be combined in one composite model, e.g. for segmenting the lungs and heart. As such, this composite model identifies a composite structure including or related to the three primitive structures left lung, right lung and the heart. Similarly, several of the same primitive models for segmenting a dorsal vertebra may be combined into a composite model for segmenting a spine. The uniform interface of the models enables the composite model to control all the constituent models in the same way and thus significantly simplifies building a composite model. Additionally, the uniform interface, by in its nature being model-independent, hides the internal working of the models. This makes it much easier to replace a constituent model by a different implementation, e.g. with improved performance, using different segmentation techniques, etc. In itself each primitive model may use any suitable segmentation technique to estimate parameter for the primitive structure for which it is designed. The composite model needs not to be aware of any implementation aspect of the underlying primitive models. The modular framework according to the invention can be used to implement object segmenters for different applications. The re-use of already developed segmenters will allow rapid progress by building on existing techniques instead of restarting from scratch. The framework also stimulates improvement to existing primitive models, since an improved model can be applied without any effort in any composite model that already used a predecessor of such primitive model, even if the newly developed model is based on different segmentation techniques. Particularly, in medical imaging many objects are quite complex, but can be split up into different parts that are simpler and easier to find. Also, neighboring structures and objects are often easier to find than the object of interest itself, which can help in locating and segmenting that object of interest. In this way, a high quality composite model can be constructed based on existing, and usually simpler, primitive models.

As described in the dependent claim 3, the constituent model in itself can also be a composite model built using constituent models. As such, a hierarchy of models can be built. By using the same interface for any constituent model (irrespective of the type, like primitive of composite) the distinction between the types of models disappears. This simplifies using the composite models as an element in a hierarchically more composite model. The composite model may be combined with one or more primitive models to give the hierarchically higher composite model. For example, a composite model for locating a vein can be built using several (the same) primitive models for locating a centre of a vein/artery. By combining the composite vein/artery model with a heart model it is very easy to build a hierarchically higher model for segmenting the heart and the coronary artery. According to the invention, a composite model is also an object finder, and behaves in much the same way as the simple primitive models. These combined models can in their turn be used to construct even more complex models in a hierarchical way.

In many cases a constituent structure will be a part of the composite structure for which it is used. However, it may also have a predetermined relationship to the composite structure (e.g. it is a neighboring structure) without forming part of the composite structure.

In a preferred embodiment as described in the dependent claim 4, the constituent model is a spring model for modeling a relative position of at least two constituent models of the composite model with respect to each other. When two or more constituent models are combined in a composite model, the relationship between the constituent models needs to be described in the composite model. According to the invention, this relationship is described in the form of a spring model. This further simplifies the development of composite models. The method according to the invention thus enables combining primitive or composite models into more complex and powerful models by using connection primitives (like springs in a mechanical model). Preferably, the spring models use the same uniform interface as used for the primitive (and composite) models. By using a same approach for all types of models, development times and the chance of implementation errors are reduced. In a simple form, a spring model represents the position of two models with respect to each other. If so desired, also spring models may be used that can model the respective position of more than two models.

As described in the dependent claim 5, the spring model is operative to represent at least one of the following: distance between the at least two constituent models; angle between the at least two constituent models; relative scale between the at least two constituent models.

As described in the dependent claim 6, the model interface enables setting at least one of the following parameters of a corresponding model: position of the model, scale of the model, orientation of the model. Every model—being either a primitive model, a composite model or a spring model—has its own set of parameters. This means that a higher level composite model doesn't have to know about the details of its composite parts. Only a limited amount of information such as pose and/or scale needs to be controllable by a higher level model (and/or at the highest level by an application program). The models can be extended step-by-step, gradually adding more power to the segmentation models. This modular approach also allows different researchers to develop their own models, and afterwards fitting them in as a new module.

As described in the dependent claim 7, the model interface enables instructing a corresponding model to perform at least one of the following operations: optimizing a fit of the model to the signal, calculating a measure of fitting of the model to the signal, determining a boundary of the model in the signal. In this way, the composite model can optimally control the constituent models to perform part of its own task. Preferably, the interface also enables specifying a type of fitting optimization. The model (or application) using the interface needs not to be aware of the actual implementation of the fitting.

As described in the dependent claim 8, the interface of a model provides at least one of the following output information of a corresponding model: position of the model, scale of the model, orientation of the model, a measure of fitting of the model, a boundary of the model. The measure of fitting can also be referred to as “goodness-of-fit”. Such a measure may be expressed in any suitable way, such as energy or likelihood. The uniform feedback of the models to a hierarchically higher model and/or an application program simplifies development.

To meet the object of the invention, a method of estimating parameters of a model of a composite structure with respect to an N-dimensional signal, N≧2, in particular for segmenting a medical image, includes:
using a composite model of the composite structure that is based on a plurality of constituent models that each correspond to a respective predetermined constituent structure in the N-dimensional signal and that are incorporated in or related to the composite structure; each constituent model being designated for estimating parameters of the constituent model with respect to the N-dimensional signal based on respective prior knowledge of the constituent structure, at least two of the constituent models being based on differing technologies; and each constituent model being provided with a uniform, predetermined interface for controlling the constituent model and for retrieving parameters estimated by the constituent model;
controlling the constituent models to estimate parameters of the constituent model;
retrieving estimated parameters from the constituent models; and
estimating parameters of the model in dependence on the retrieved parameters. In this way, the parameters of a composite model can be calculated efficiently. The models controls its constituent models via the uniform interface, retrieves the parameters from each constituent model and bases its own estimate thereon. The constituent model may be a primitive model, composite model and/or spring model.

As described in the dependent claim 14, the estimated parameters are also based on contribution of the models itself, for example for parts of the composite structure not covered by the constituent structures.

As described in the dependent claim 15, each constituent model of the composite model is operative to adjust a fitting to the signal in response to an instruction via its interface; the step of constructing a segmentation of the composite structure including optimizing a fitting of the composite model to the signal by instructing each constituent model to adjust its fitting to the signal. The task of fitting a composite model to the signal is significantly simplified by giving the constituent models the task to adjust their fitting, effectively (partly) decentralized the task of the composite model and giving it to the constituent models.

The hierarchical modeling according to the invention enables several ways of optimizing a fit of the model. A first way as described in the dependent claim 16 is a ‘propagation approach’, where a first (preferably easy to find) model is fit to the data, and this information is propagated to its ‘neighboring’ models to help finding their own best fit solution.

The dependent claim 17 described a ‘pose optimization approach, wherein the pose (positions, orientation and/or scale) of the composition model is adjusted. The resulting pose changes to the constituent models are calculated and the constituent models are instructed to perform the adjustment. The outcome in fitting is retrieved from the constituent models and used for calculating the fit of the composite model.

The dependent claim 18 describes an ‘element pose optimization’ approach, wherein each constituent model is instructed to change its pose until a globally optimal fit has been achieved. The results are retrieved and combined for the composite model.

In a last step, as described in the dependent claim 19, the constituent models can be maximally optimized using their own energy optimizer and may not only adjust their pose but may also deform.

To meet the object of the invention, an apparatus for estimating parameters of a model of a composite structure with respect to an N-dimensional signal, N≧2, in particular for segmenting a medical image, includes:
an input for receiving the N-dimensional signal;
a storage for storing a composite model of the composite structure that is based on a plurality of constituent models that each correspond to a respective predetermined constituent structure in the N-dimensional signal and that are incorporated in or related to the composite structure; each constituent model being designated for estimating parameters of the constituent model with respect to the N-dimensional signal based on respective prior knowledge of the constituent structure, at least two of the constituent models being based on differing technologies; and each constituent model being provided with a uniform, predetermined interface for controlling the constituent model and for retrieving parameters estimated by the constituent model;
a processing system for estimating the parameters by:
   controlling the constituent models of the composite model to estimate parameters of the constituent model;
   retrieving estimated parameters from the constituent models; and
   estimating parameters of the model in dependence on the retrieved parameters; and
an output for outputting the estimated parameters.

These and other aspects of the invention are apparent from and will be elucidated with reference to the embodiments described hereinafter.

### BRIEF DESCRIPTION OF THE DRAWINGS

In the drawings:

FIG. 1 shows the hierarchical modeling according to the invention;

FIG. 2 shows an example of a composite model for a human chest;

FIG. 3 illustrates pose optimization of the model;

FIG. 4 illustrates element pose optimization;

FIG. 5 illustrates element deformation optimization;

FIG. 6 shows optimization by propagation;

FIG. 7 illustrates building a composite model from constituent models

FIG. 8 illustrates the method of composing a model;

FIG. 9 illustrates the method of estimating model parameters; and

FIG. 10 shows block diagram of an apparatus for estimating model parameters.

### DETAILED DESCRIPTION OF THE PREFERRED EMBODIMENT

The framework according to the invention is applicable to N-dimensional signals, N≧2. In particular the hierarchical modeling can be used for segmenting 2 or 3-dimensional images, optionally given as a time sequence of 2 or 3-dimensional images (as a 3^{rd} or 4^{th} dimensional). Non-limiting examples will be given for segmenting 2-dimensional medical images and medical apparatuses. It will be appreciated that the models can also be used for other purposes than segmenting, e.g. to perform a direct measurement on the signal, and can also be used for other areas than medical images.

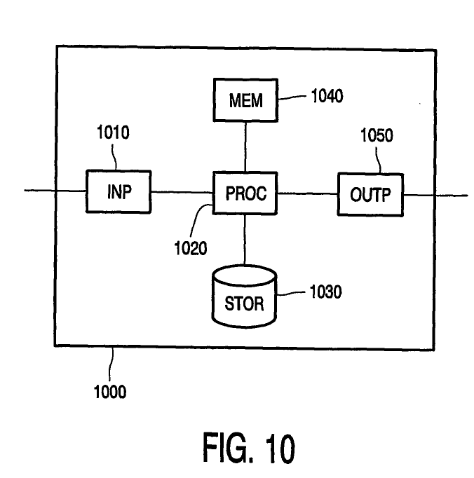

The invention relates to a method of constructing the hierarchical models as well as to methods using the hierarchical models for segmenting the N-dimensional signal. According to the invention, the models (as will be described in more detail below) are designated for segmenting a corresponding structure in the signal. As such the models encapsulate all knowledge and functionality for doing such a task. It will be appreciated that every detail given of model applies both to the method of constructing a model as well as to segmenting a signal using the model. The invention also relates to the software incorporating such methods and to apparatuses including means for performing such methods. The apparatuses are typically based on conventional computer systems, particular those generally used for processing medical images. FIG. 10 shows an exemplary apparatus. The apparatus has an input 1010 for receiving the signal in any suitable form. For example, the apparatus may be involved in the acquisition of the signal. In this case the signal may be received in an analogue form and converted using a suitable A/D converter to a digital form for further processing. The signal may also be received in a digital form, e.g. through direct acquisition in a digital form or via a computer network after having been acquired by another computer/medical instrument. The core of the apparatus is formed by a processor 1020, such as a conventional microprocessor or signal processor, a background storage 1030 (typically based on a hard disk) and working memory 1040 (typically based on RAM). The background storage 1030 can be used for storing the signal (or parts of it) when not being processed, and for storing the models (when not being executed by the processor). The main memory 1040 typically holds the (parts of) the signal being processed and the models used for processing those parts. An output 1050 is used for outputting the result. For example, if the processor has been loaded with a segmenting program (e.g. retrieved from the storage 1030) for segmenting the signal using models stored in the storage 1030, then the output may be a segmented structure, e.g. visually indicated on a display.

A primitive model is an elementary building block of the composite modeling according to the invention. In the description a primitive model is also referred to as ‘primitive’. Each primitive model is designed to segment a corresponding primitive structure (also referred to as primitive object) in an N-dimensional signal (N≧2). With a structure is meant a region, or objects of interest in pictures or images. As such, each primitive model has a-priori knowledge of its corresponding primitive structure. A primitive model will look for a specific part (i.e. the primitive object) of the entire object. Of course, the entire object can also be the primitive object. Each primitive object is fully autonomous. It can perform the segmenting of the primitive structure for which it is designed without the aid of other models. It can be controlled by an application program or hierarchically higher model via its interface.

Examples of primitive model technologies are:

Point finder model that will look for image locations with a strong response to a matching criterion (maximum gradient, corresponding grey-value template, corner detector etc.)

Models for geometrical primitive surfaces like sphere, cylinder, plane, line. These primitives will fit their surfaces to parts of the image with e.g. a high edge strength.
Models for geometrical primitive volumes like half-plane, filled sphere. These primitives will try to obtain a desired grey-value distribution of the grey-values inside their volume.
Models for hyper-quadrics: roughly said, this is a smoothed version of a convex polyhedron defined by N planes
Models for active objects: the 3 dimensional variant of active contours
Shape model: performs statistical analysis (Principal Component Analysis) on a training set to extract the ‘eigenshapes’ of an object, and uses these to model all objects
Appearance model: as a shape model, but the grey-values (appearance) are also modeled
Level set: this is an implicit description of a N-dimensional surface by defining an N+1 dimensional function of which the zero-crossing represents the N-dimensional surface. A Level Set also has an energy (goodness-of-fit), and can evolve to better adjust the surface to the image information.

Preferably, primitive models have a set of specific, private parameters that need not to be known to the higher level model. These parameters will have a default value at creation of the primitive, and be adapted during the fitting stage. If these parameters have to be exported (e.g. as measurement values), specific functions/methods have to be used. Examples of primitive specific parameters are:
node positions in a 3d active object
weights of eigenmodes in a statistical shape model (n-dimensional)
radius of a sphere
voxel values of a level set

In the hierarchical framework according to the invention, the fitting algorithm (energy optimizer) can be specific for the primitive model. Preferably, every primitive includes an optimizer, but these can have very different implementations that don't have to be known at the higher level. For the invention it is not relevant which fitting algorithm is used by a specific model. It is preferred that models use optimal fitting algorithms designed for the specific structure to be segmented. As such a range of fitting algorithms may be used by the various models.

Preferably, primitive models also have a set of common variables and methods. This allows the modular composition of primitives, and easy replacement of one primitive by a different one. Common variables and methods can be selected from the following options:
pose: pose is the position (the origin point), orientation (direction of the principal axes, e.g. x, y, z-axes) and scale of the object (along the principal axes). For all primitive models the pose variables can be defined. In a preferred embodiment, it is the only set of controllable ‘public’ parameters, exported outside of the primitive, meaning that higher level models can then only influence pose of a lower level primitive.
energy value: for every primitive model, an energy can be calculated based on the goodness-of-fit on the image data (external energy part) and/or the likelihood of the model (internal energy part). The calculation may be primitive-specific, but preferably every primitive will have a goodness-of-fit value available to a higher level. Persons skilled in the art will be able to apply or design a suitable algorithm for calculating how well the model fits the data.
energy optimizer: every primitive model preferably has its own function to optimize its energy. The implementation of this optimizer may be dependant on the actual primitive model at hand, and can range from very simple energy optimizers (maximum gradient point finder) to more complex systems (active object, level set). Persons skilled in the art will be able to apply or design a suitable algorithm for a fitting of the model to the data
boundary: most primitive models also have a boundary, either implicitly described (geometrical primitive, level set) or explicitly defined (active object). This boundary can be used for visualization, for user interaction and as output of the segmentation process. Constraints imposed on the object surface (like non-intersection of 2 objects) will also need this boundary. For some degenenerate cases such as point and line we can still define a boundary as being the point/line itself.

The primitive models are provided with a uniform, predetermined interface for controlling the model. Through the interface above parameters and methods, like the ones described above, are accessible/controllable.

In a preferred embodiment, the common framework according to the invention is supported by the design and implementation of (a number of) these primitive models in a common language. An object oriented approach, like programming in C++, suits the hierarchical model with hiding of internal aspects very well. In such an approach (or similar approach), for all primitives the same public methods can be implemented, for example:
setpose: put the primitive model in a certain pose. This can be done based on user information, it can be a default value, or the pose can be calculated by a higher level model that already gathered more information.
getpose: ask a primitive model for its pose, this is done after the primitive fitted itself to the data and changed its pose doing this
optimisePose: this will cause the primitive model to find its best fit (minimal energy solution) by modifying its pose
calculateEnergy: calculate the internal+external energy of the primitive model
optimiseEnergy: find the optimum energy solution by modifying the specific and pose parameters. It is more general than ‘optimisePose’ because specific parameters will also be modified (this results in a free form deformation compared to the similarity transformation that is done in optimisePose).
getBoundary: get the surface of the primitive model, expressed in e.g. a point cloud, a mesh, vtkPolyData object etc.

The interface described above enables to:
set parameters, like position, scale, and orientation, of a corresponding model;
instruct a corresponding model to perform an operations, like optimizing a fit of the model to the signal, calculating a measure of fitting of the model to the signal, and/or determining a boundary of the model in the signal
obtain output, such as position, scale, orientation, measure of fitting, and boundary, of a corresponding model.
   Composition of Primitives

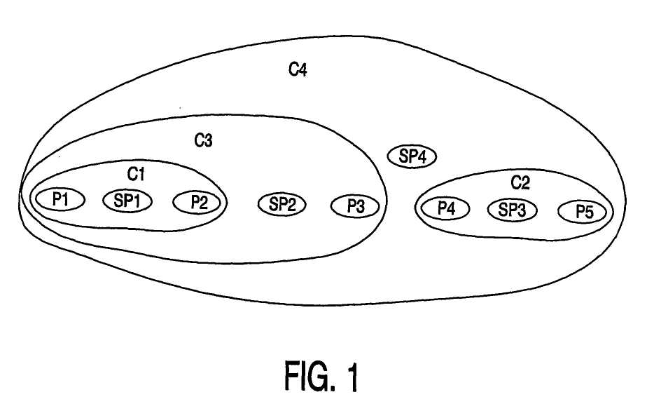

Starting from a set of primitive models, according to the invention a composite model for segmenting a higher level object is formed. FIG. 1 shows an example of a hierarchical composition. The figure shows five normal primitive models, indicated by P1 to P5, and four special primitive models SP1 to SP4, representing spring models, as will be described in detail below. The spring models describe the relationship between models, either primitive or composite models. There can be different types of spring models, for example for modeling a distance or angle between the models. In the example, one composite model is built using at least two constituent models (ordinary primitive model or a composite model) and one spring model. The number of constituent models and spring models can vary. FIG. 1 shows four constituent models C1 to C4. Model C1 is based on the primitive models P1 and P2 and spring model SP1. Composite model C3 is built using C1 and one additional primitive model P3 and one spring model SP2. Composite model C2 is built using primitive models P4 and P5 and the spring model SP3. Finally, composite model C4 is built using composite models C2 and C3 and spring model SP4.

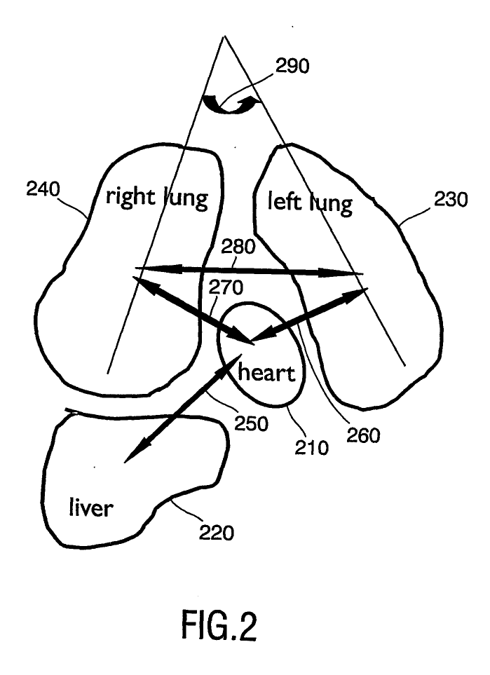

FIG. 2 shows an example of a composite model according to the invention. The composite model has the following constituent (primitive) models: a heart model 210, 1 liver model 220, a left lung model 230, and a right lung model 240.

In a preferred embodiment a composite model has the same properties as the primitive models themselves: the composite model also has at least one of the following: a pose and scale, specific parameters, and an energy function. Therefore, the composite model can be treated as an object with the same methods as the primitives themselves. This allows effective building of hierarchical models of primitive models and other composite models.

Since a primitive model can be missing (partial scan, pathological case), the composite model preferably is designed to cope with missing components if this is indicated in the model.

Creating of a composition model can be simplified by using one or both of the following methods:
composition using springs
Preferably, a new primitive model, referred to as a spring model, is used. This model functions to tie a primitive model to a fixed position/angle, and/or to describe the relationship between at least two primitives, where the relationship covers at least one of the expected distance, angle or scale. The energy of the spring is determined by the distance between the primitive models (in the example of a position spring), and this energy will be zero at the rest length of the spring (which is the expected distance between the 2 primitives). The spring model can also be put into the general framework of primitive models, and the same methods can be implemented. In this way, primitive models can be interconnected by attaching springs to their origins.
composition using statistical knowledge
Primitive models can also be composed using a statistical model for topology. Starting from a set of training examples, statistics can be derived about the most likely configurations (e.g. using PCA methods). A training example in this context refers to a series of pose and scale parameters for each primitive and forms one n-dimensional vector. Note: if mono-gaussian statistics (average and covariance) are calculated on the pose and scale of each primitive independently (ending up in 4 statistical models for the thorax example), this model is equivalent to a spring model.
   FIG. 2 shows the use of four distance spring models 250, 260, 270, 280 each for connecting two primitive models. An angle spring (290) is also used, and connects the orientation of primitives 230 and 240.
   Energy Calculation

The energy of a composite model is the sum of the energy of its elements, which are either primitives or other composites. Since every object can have its own method to calculate its energy, the composite model just has to ask for these values, add the composite contribution and combine this into one single energy value. Weighting of the different contributions can be done at this level. The likelihood of the topology (internal energy of the composite model) can be expressed as the energy from the springs only. This energy approach is completely equivalent to a Bayesian probabilistic approach, if an energy is defined as a -log(likelihood). Prior information (from an expert, or from training) can be expressed as an internal energy.

As described above, a spring models describes the connection between two or more models. The spring model has an energy attached to it, dependent on the parameters of the connected models. Based on the parameter the spring model is designed to relate, a distinction can be made between the following types of spring models:
position springs
angle springs
scale springs
   A position spring has an energy E that depends on the positions of the N models it connects: E=f(x₁, y₁, x₂, y₂, . . . x_{N}, y_{N}) for 2-dimensional positions. A similar function can be written for a scale spring: E=f(s₁, s₂, . . . , s_{N}), or for an angle spring. In general: the spring energy for the 2d case can be written as: E=f(x1, y₁, a₁, s₁, . . . , x_{N}, y_{N}, a_{N}, S_{N}) where x,y is position, a the angle and s the scale.

A spring model can minimize its energy, with possible effects:
attract two models if their current positions are further apart then the ‘rest length’ (zero energy length) of the spring
repulse them if they are closer than the rest length
change the scale of the N models that are connected with a scale spring so that they all have similar scales (sizes).
   The spring energy functions can take all kinds of forms. A simple form is a linear spring: E=−k*((x₁−x₂−l)²+(y₁−y₂−l)²) where l is the rest length and k the spring constant. The spring is called linear because the force is proportional to the displacement, and so the energy is quadratic with displacement. These functions should be ‘well behaved’ (i.e. smooth) to allow a good energy minimization. A spring can connect two or more models. With more than two models, it is difficult to draw a mechanical counterpart, but the mathematics stays simple and is well-known to persons skilled in the art.
   Energy Optimization

Preferably, a composite model is able to minimize its energy. It can do so by using the energy optimizers of its constituents, and playing with the pose and scale parameters of these constituents. The total energy of the composite model can be seen as a (non-linear) function of its parameters and the image: Eₜₒₜ=g(x₁, y₁, a₁, s₁, hidden parameters₁, . . . , image). In general, several energy minimizing methods are known for optimizing such a function. Since the function is not analytically known, iterative numeric schemes are used. For example, optimize by changing the models' poses (xᵢ, yᵢ, aᵢ, sᵢ), keeping the internal parameters constant. This can be solved by starting from a given initial situation (the user defined starting position for example), then ‘look around’ in the neighborhood, and deciding in what direction to go to maximally reduce the energy. As an example we can look at N vertebra finders connected with a scale spring. This means e.g. that the variation in the N scales should be minimal. The optimizer will look around by slightly modifying all the parameters one by one, and then looking how the energy behaves. If he brings the scales closer together, he will notice a strong energy reduction, and that will thus be the preferred adjustment to apply to the parameters. This process continues until an equilibrium is reached between the energy term that minimizes the scale variation, and other energy terms that optimize e.g. the fit on the image. A different optimization method will first minimize the energy by modifying x₁, y₁, a₁, s₁, then starting from the found energy minimum, optimizing x₂, y₂, a₂, s₂, etc, until all the parameters have been modified. This is an optimization by propagation. Preferably, a composite supports at least one of the following methods to optimize the energy of the composite model:
optimization by propagation
In the implementation of the energy optimizer of the composite model, first one constituent model (C1) is optimized. This can be an easy-to-detect structure (like a bony structure), or a part that is attached to a user-defined starting point. The result of the optimization is a new set of specific parameters for C1 (unknown at the level of the composite model), and a new value for the pose and scale (known at the composite level). The composite model can optimize its energy by fixing pose and/or scale of C1, and modifying the pose and/or scale of all other constituents C. Thus a better starting estimate for all the other C's is obtained. A next C is selected, based on a selection criterion (fixed order of C's, or choosing the C with the lowest energy), and the process is repeated.
pose optimization
The pose (position, orientation and scale) of the entire composite model can be modified to obtain the minimal energy solution. This corresponds to a similarity transform of the entire model (4 parameters in 2D, 7 in 3D). The optimization can be done in a robust way because of the limited number of parameters. Optimization is done completely by the composite model, who asks the primitives and connections to calculate their energy.
element pose optimization
The total composite model energy can also be optimized by modifying the individual poses of the different primitives. The composite model then modifies its shape, but the primitives only undergo a similarity transform. Here too, optimization is completely done by the composite model.
element deformation optimization
One step further will lead to the local deformation of the individual primitives. Since the composite model doesn't know how to deform and optimize the individual primitives, he should invoke the ‘optimiseEnergy’ methods of the primitives.
Hierarchical optimization
The three previous optimizations can be combined in a top-down approach. Starting from a global pose (user defined, trained or an educated guess as default), the highest level composite minimizes its energy by adapting its own pose and scale (pose optimization). In a second step, the primitives P optimize their pose. Finally, all P's are optimized in their turn, tuning their own parameters, until the bottom level is reached.
   The decision of what energy optimizer to use is preferably coded in the model at the composite level. A simple flag can be set which method is to be used. In the case of optimization by propagation, the order in which the components should be optimized should also be coded in the composite model.

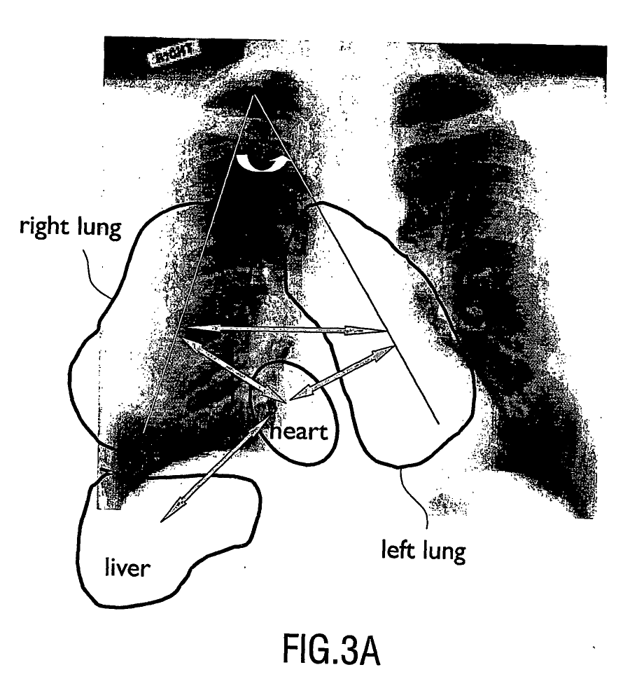

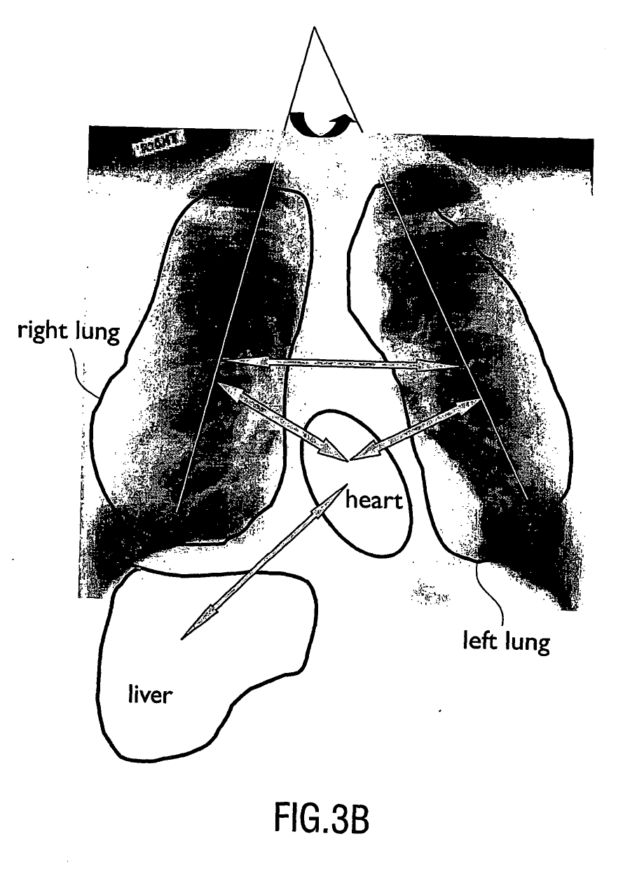

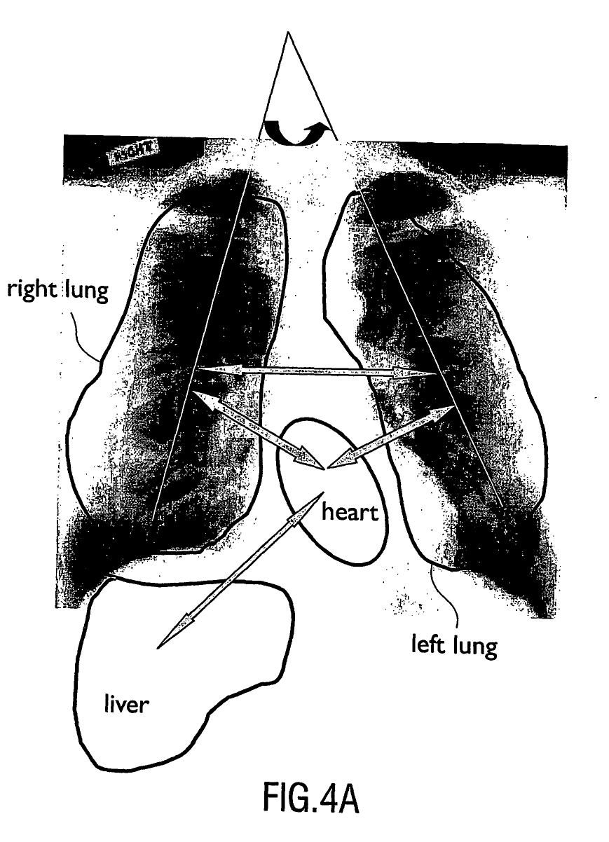

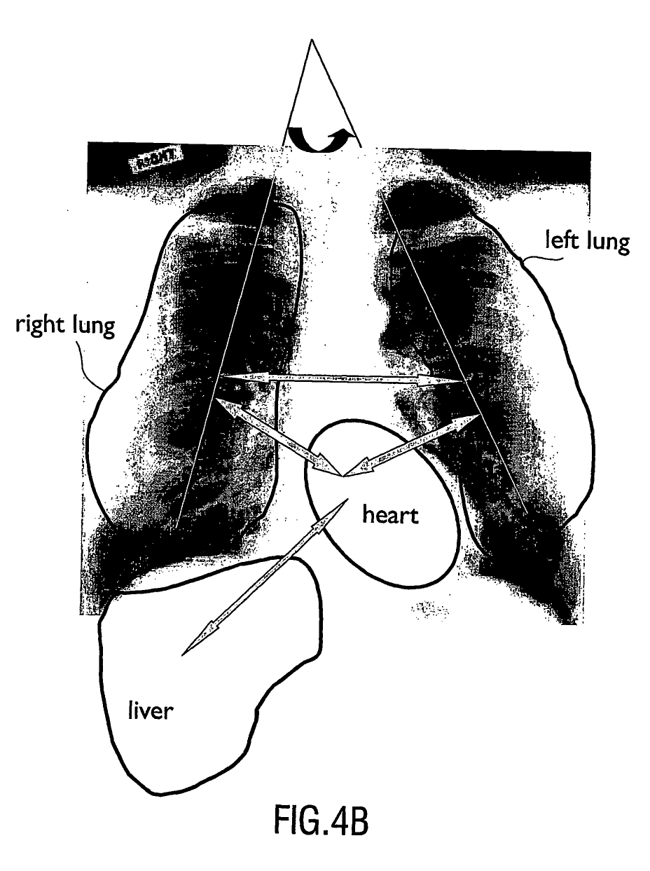

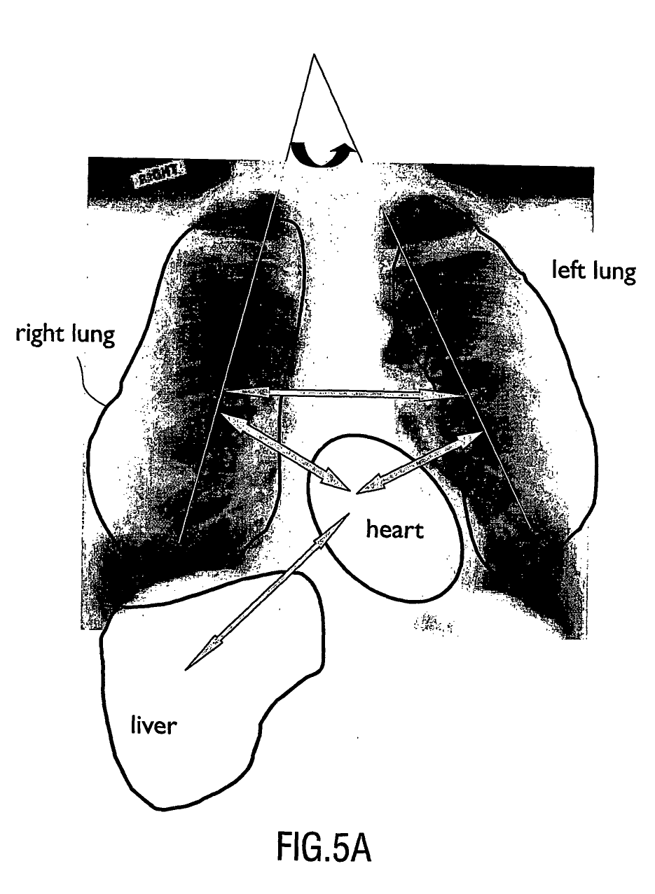

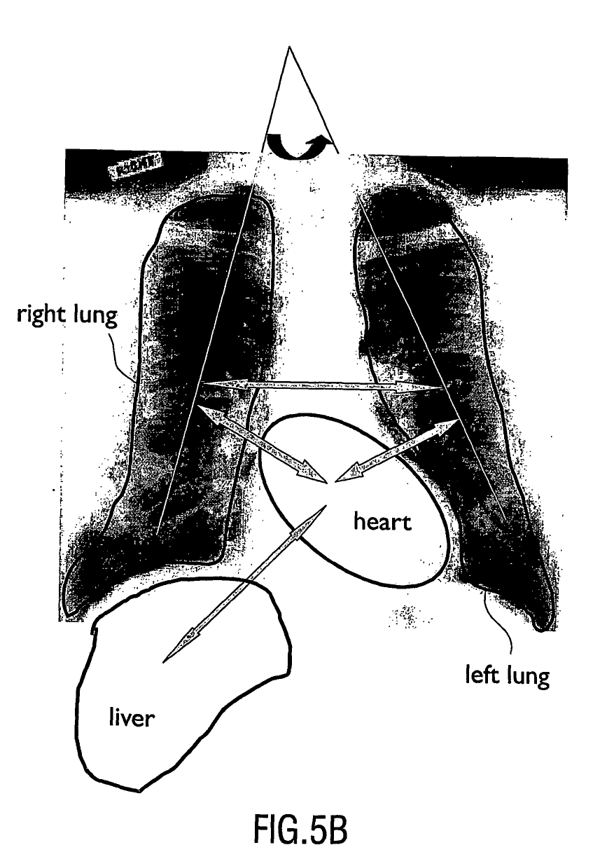

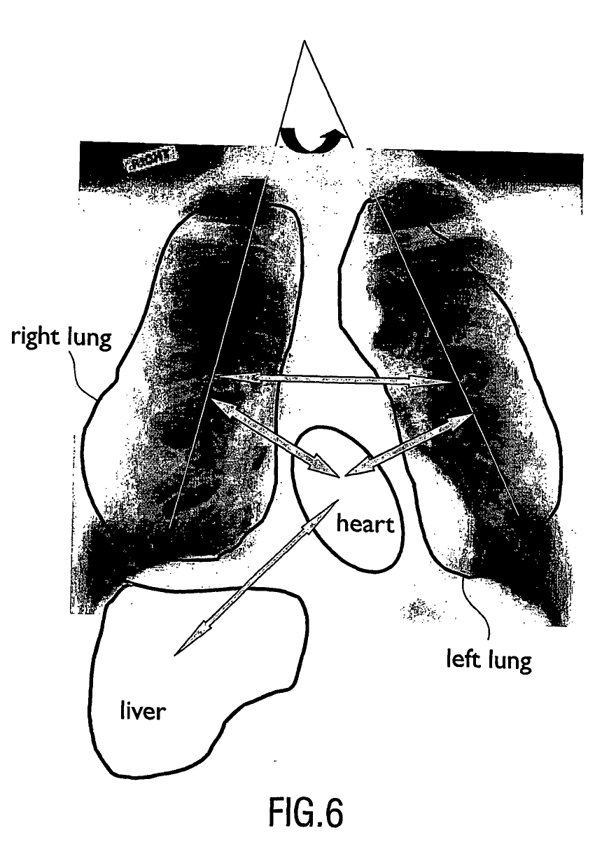

The various energy optimization methods are illustrated in FIGS. 3 to 6. The composite model of FIG. 2 is fitted to a chest X-ray (shown in the background of the Figs). FIGS. 3a, 4a, and 5a shows the starting point before the optimization is performed. FIGS. 3b, 4b, and 5b show the end result of the optimization. FIG. 3 illustrates a similarity transform of the entire composite model, referred to as pose optimization above. FIG. 4 illustrates a similarity transform of each of the constituent models independently, referred to as element pose optimization above. FIG. 5 illustrates deforming each constituent model according to its own deformation strategy, referred to as element deformation optimization above. FIG. 6 illustrates successive optimization of every constituent model, referred to above as optimization by propagation. In this example, first the right lung was positioned, then the left lung, followed by the heart, and finally the liver.

Model Constraints

Until now, no model constraints were discussed. In some applications it is preferred to impose a certain allowed range of some parameters (distance, length, angle). Also, intersection of the object surfaces should usually be avoided. In a preferred embodiment, the framework is extended to allow such constraints, and the optimizer is designed to take such constraints into account.

Examples of Composite Model Applications

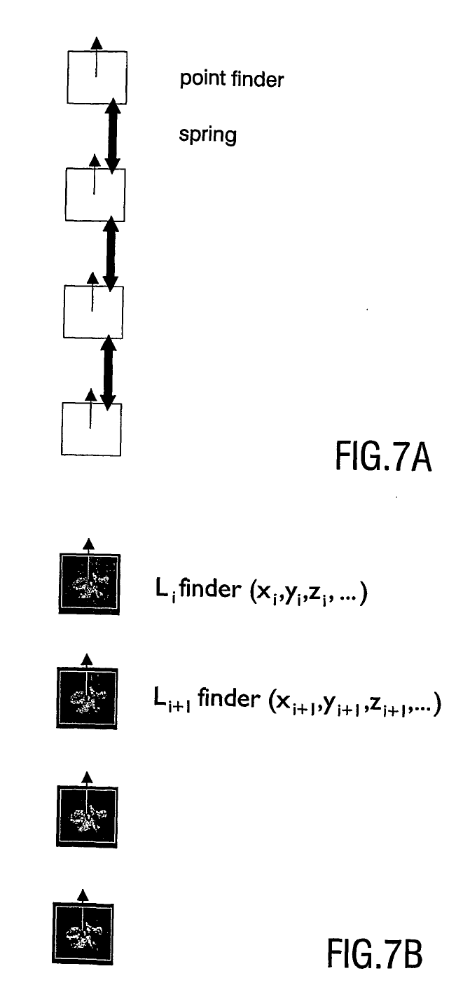

The following is a non-limiting list of examples of composite models:
Lung segmenter
A rough model of the left and right lung, the heart, the spine etc. can be applied to a CT or MR dataset to obtain a first segmentation of the lungs. More detailed models can be used in a second step of the segmentation process if this is required.
Vessel centerline extractor
A contrasted blood vessel can be segmented by a chain of point finders, connected with distance and angle strings. This resembles an open active contour, but it is much easier to implement once the building blocks are present. Energy optimization can start from a user-defined points, and propagate to the neighboring vessel points. The point finder looks for the center point of a vessel, and contains information about the vessel orientation. Springs can impose a certain constant sampling of the vessel line, and angular springs can be added to impose curvature constraints on the vessel centerline.
Spine segmenter
Using a similar approach, we can construct a spine model. Instead of using points finders, we can use vertebra finder, which can be either a complicated vertebra shape model, or a simple pill-box finder. A rough segmentation of the spine can be used to automatically remove the spine when creating Maximum Intensity Projections for CT angiography. FIG. 7A illustrates how such a composite model can be built from constituent models. Shown are the constituent models 710, 720, 730, and 740 which each are a model for finding a specific vertebra and the constituent models 750, 760, and 770 which each are spring models connecting two vertebra models. FIG. 7B illustrates fitting the composite model to an image of a spine (shown are only segments of a spine).
Abdomen segmenter
The abdomen can also be segmented automatically. The easier-to-detect parts are the pelvis and spine. In some scans, the colon will be filled with air, and can also be detected and segmented. Once the spine is roughly localized, the kidneys can be looked for. If an intravenous contrast medium was used, the blood vessels (aorta, renal arteries) can be isolated as well.

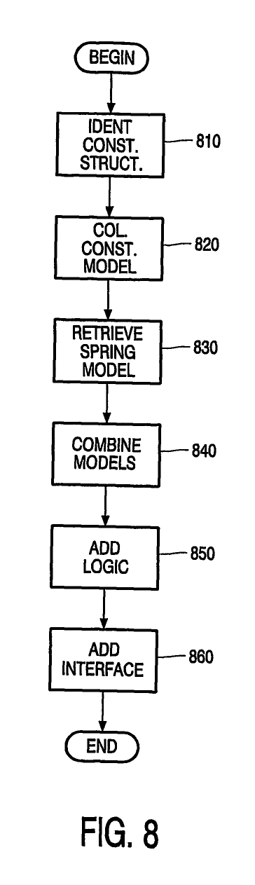

FIG. 8 illustrates a method of constructing a composite model. In the figure it is assumed that already suitable primitive models have been constructed for the respective primitive structure that are part of or are related to the composite structure for which the composite model is being designed. If such primitive models have not been designed such models may be designed in a suitable way and provided with the uniform interface according to the invention. In step 810 the constituent structures are identified. Typically, this task will be performed under control of a human operator. For example, the operator may in a sample signal identify one or more constituent structures. If so desired, also in an automatic operation models of a collection of constituent structures their associated models may be matched against the signal. If a high likelihood is achieved, use of such a model may be proposed to an operator (or even automatically incorporated in the model being built). The constituent structure may be a primitive structure or a composite structure for which at an earlier moment already a composite model has been made. Each constituent structure is associated with a constituent model. In step 820 the constituent models associated with the identified constituent structures are loaded, e.g. retrieved from a background storage. In step 830, optionally one or more spring models are retrieved for coupling constituent models. The spring models are preferably coupled to constituent models, identified by an operator. If so desired, spring models may also be added automatically, e.g. one position spring model is added for each pair of constituent models. In step 840, the constituent models, including the spring models, are combined. In step 850 logic is added for controlling the constituent models through their uniform interfaces. Specific logic may be added to perform the various optimization algorithms of a composite model. In step 860, the uniform interface is added to the composite models, enabling re-use of the composite model by a hierarchically higher composite model.

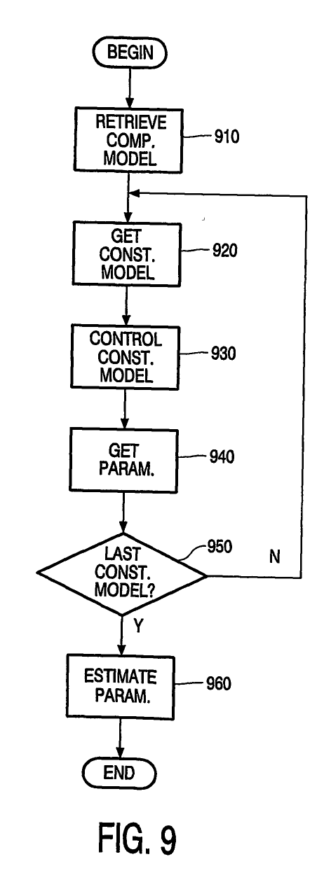

FIG. 9 illustrates a method of estimating parameters of a model of a composite structure with respect to an N-dimensional signal, N≧2, in particular for segmenting a medical image. In step 910 a composite model of the composite structure is retrieved, e.g. from a background storage. The composite model is based on a plurality of constituent models that each correspond to a respective predetermined constituent structure in the N-dimensional signal and that are incorporated in or related to the composite structure. Each constituent model is designated for estimating parameters of the constituent model with respect to the N-dimensional signal based on respective prior knowledge of the constituent structure. At least two of the constituent models are based on differing technologies. Each constituent model is provided with a uniform, predetermined interface for controlling the constituent model and for retrieving parameters estimated by the constituent model. In step 920, the composite model gets control over one of the constituent models. In step 930 the composite models uses its logic to control the constituent model to perform a task, e.g. to adjust its positions, or to fit optimally to the signal, as chosen by the composite model (possibly in response to a signal from an operator controlling the composite model). Among others, the composite model controls the constituent model to estimate parameters of the constituent model. In step 940 it retrieves the estimated parameters from the constituent model. In step 950, the composite model checks whether all constituent models have been controlled and reported the parameters back. If not, the next model is selected in step 910. If so, in step 960 the constituent model estimates the parameters of the composite model in dependence on the retrieved parameters.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The words “comprising” and “including” do not exclude the presence of other elements or steps than those listed in a claim. The invention can be implemented by means of hardware comprising several distinct elements, and by means of a suitably programmed computer. Where the system/device/apparatus claims enumerate several means, several of these means can be embodied by one and the same item of hardware. The computer program product may be stored/distributed on a suitable medium, such as optical storage, but may also be distributed in other forms, such as being distributed via the Internet or wireless telecommunication systems.

1. A method of constructing a model of a composite structure for estimating parameters of the model with respect to an N-dimensional signal, N≧2, in particular for segmenting a medical image; the method including:
constructing a plurality of constituent models, each constituent model corresponding to a respective predetermined constituent structure and being designated for estimating parameters of the constituent model with respect to the N-dimensional signal based on respective prior knowledge of the constituent structure, at least two of the constituent models being based on differing technologies; and each constituent model being provided with a uniform, predetermined interface for controlling the constituent model and for retrieving parameters estimated by the constituent model; and
constructing the model by determining at least two constituent structures that are incorporated in or related to the composite structure and forming the composite model based on respective constituent models that correspond to the respective determined constituent structures; the model being operative to control the constituent models, to retrieve estimated parameters from the constituent models and to estimate parameters of the model in dependence on the retrieved parameters.

2. A method as claimed in claim 1, wherein the constituent model is a primitive model corresponding to a respective predetermined primitive structure in the N-dimensional signal and being designated for estimating the model parameters solely based on prior knowledge of the primitive structure without using further models for estimating parameters of the model with respect to the signal.

3. A method as claimed in claim 1, wherein the constituent model is a composite model corresponding to a further composite structure for estimating parameters of the composite model with respect to the N-dimensional signal by determining at least two of the constituent structures that are incorporated in or related to the further composite structure and forming the composite model based on respective constituent models that correspond to the respective determined constituent structures; the composite model being operative to control the constituent models, to retrieve estimated parameters from the constituent models and to estimate parameters of the composite model in dependence on the retrieved parameters.

4. A method as claimed in claim 1, wherein the constituent model is a spring model for modeling a relative position of at least two constituent models of the model with respect to each other.

5. A method as claimed in claim 4, wherein the spring model is operative to represent at least one of the following:
distance between the at least two constituent models;
angle between the at least two constituent models;
relative scale between the at least two constituent models.

6. A method as described in claim 1, wherein the interface enables setting at least one of the following parameters of a corresponding model:
position of the model,
scale of the model,
orientation of the model.

7. A method as claimed in claim 1, wherein the interface enables instructing a corresponding model to perform at least one of the following operations:
optimizing a fit of the model to the signal,
calculating a measure of fitting of the model to the signal,
determining a boundary of the model in the signal.

8. A method as claimed in claim 1, wherein the interface enables obtaining at least one of the following output information of a corresponding model:
position of the model,
scale of the model,
orientation of the model,
a measure of fitting of the model,
a boundary of the model.

9. A computer program product for causing a processor to perform the method of claim 1.

10. A method of estimating parameters of a model of a composite structure with respect to an N-dimensional signal, N≧2, in particular for segmenting a medical image; the method including:
using a composite model of the composite structure that is based on a plurality of constituent models that each correspond to a respective predetermined constituent structure in the N-dimensional signal and that are incorporated in or related to the composite structure; each constituent model being designated for estimating parameters of the constituent model with respect to the N-dimensional signal based on respective prior knowledge of the constituent structure, at least two of the constituent models being based on differing technologies; and each constituent model being provided with a uniform, predetermined interface for controlling the constituent model and for retrieving parameters estimated by the constituent model;
controlling the constituent models to estimate parameters of the constituent model;
retrieving estimated parameters from the constituent models; and
estimating parameters of the model in dependence on the retrieved parameters.

11. A method as claimed in claim 10, wherein the constituent model is a primitive model corresponding to a respective predetermined primitive structure in the N-dimensional signal and being designated for estimating the model parameters solely based on prior knowledge of the primitive structure without using further models for estimating parameters of the model with respect to the signal.

12. A method as claimed in claim 10, wherein the constituent model is a composite model corresponding to a further composite structure for estimating parameters of the composite model with respect to the N-dimensional signal by determining at least two of the constituent structures that are incorporated in or related to the further composite structure and forming the composite model based on respective constituent models that correspond to the respective determined constituent structures; the composite model being operative to control the constituent models, to retrieve estimated parameters from the constituent models and to estimate parameters of the composite model in dependence on the retrieved parameters.

13. A method as claimed in claim 10, wherein the constituent model is a spring model for modeling a relative position of at least two constituent models of the composite model with respect to each other.

14. A method as claimed in any one of the claim 10, wherein the step of retrieving estimated parameters from the constituent models includes retrieving a measure of fitting of each constituent model; and wherein the step of estimating parameters of the model includes calculating a measure of fitting of the model in dependence on the retrieved measures of fitting of the constituent models and on a contribution of the composite model.

15. A method as claimed in claim 10, wherein each constituent model of the composite model is operative to adjust a fitting to the signal in response to an instruction via its interface; the method including optimizing a fitting of the model to the signal by instructing each constituent model to adjust its fitting to the signal.

16. A method as claimed in claim 15, wherein the step of instructing each constituent model to adjust its fitting includes selecting a first one of the constituents models; instructing the first constituent model to optimize its fitting; and sequentially instruct other ones of the constituent models to optimize their fitting with respect to the already optimally fitted constituent model(s).

17. A method as claimed in claim 15, wherein the step of optimizing a fitting of the model to the signal includes:
adjusting a position, orientation and/or scale of the composite model; and
for each of the constituent models:
determine derivative adjustments in a position, orientation and/or scale of the constituent model;
instructing the constituent model to perform the adjustment; and
retrieve a measure of fitting of the constituent model; and
calculating a measure of fitting of the model.

18. A method as claimed in claim 15, wherein the step of optimizing a fitting of the model to the signal includes:
for each constituent model:
instructing the constituent model to optimally adjust a position, orientation and/or scale of the constituent model; and
retrieving position, orientation, and/or scale information from the constituent model; and
determining position, orientation, scale and/or deformation of the model from the retrieved information; and
calculating a measure of fitting of the model.

19. A method as claimed in claim 15, the step of optimizing a fitting of the model to the signal includes:
for each constituent model:
instructing the constituent model to optimize its fitting to the signal; and
retrieving position, orientation, scale and/or deformation information from the constituent model; and
determining position, orientation, scale and/or deformation of the model from the retrieved information; and
calculating a measure of fitting of the model.

20. A computer program product for causing a processor to perform the method of claim 10.

21. An apparatus for estimating parameters of a model of a composite structure with respect to an N-dimensional signal, N≧2, in particular for segmenting a medical image; the apparatus including:
an input for receiving the N-dimensional signal;
a storage for storing a composite model of the composite structure that is based on a plurality of constituent models that each correspond to a respective predetermined constituent structure in the N-dimensional signal and that are incorporated in or related to the composite structure; each constituent model being designated for estimating parameters of the constituent model with respect to the N-dimensional signal based on respective prior knowledge of the constituent structure, at least two of the constituent models being based on differing technologies; and each constituent model being provided with a uniform, predetermined interface for controlling the constituent model and for retrieving parameters estimated by the constituent model;
a processing system for estimating the parameters by:
controlling the constituent models of the composite model to estimate parameters of the constituent model;
retrieving estimated parameters from the constituent models; and
estimating parameters of the model in dependence on the retrieved parameters; and
an output for outputting the estimated parameters.
